(19) United States
(12) Patent Application Publication
(10) Pub. No.: US 2005/0166419 A1
(43) Pub. Date: Aug. 4, 2005

(54) Method and apparatus for drying and storing delicate clothing

(76) Inventor: Laura Regelski, Spencerport, NY (US)

Correspondence Address: Thomas R. FitzGerald, Esq., Suite 210, 16 E. Main Street, Rochester, NY, 14614-1808, US

(21) Appl. No.: 11/027,560

(22) Filed: Dec. 30, 2004

Related U.S. Application Data
(60) Provisional application No. 60/533,849, filed on Dec. 31, 2003.

(51) Int. Cl. F26B 19/00; F26B 25/06

(52) U.S. Cl. 34/202; 34/218

(57) ABSTRACT

A clothes-drying apparatus includes a cabinet and a plurality of shelves associated with the cabinet. The shelves being movable between a first position wherein they are disposed substantially entirely within the cabinet and a second position wherein they extend at least partially from within the cabinet. The shelves define a plurality of small-diameter holes therethrough. At least one fan is disposed in association with the cabinet and creates a flow of air within and/or through the cabinet.

### CROSS-REFERENCE TO RELATED APPLICATIONS

This application claims the benefit of the filing date of U.S. Provisional Patent Application Ser. No. 60/533,849, filed 31 Dec. 2003.

### TECHNICAL FIELD

The present invention relates to a method and apparatus for drying delicate items of clothing.

### BACKGROUND

The conventional devices for and methods of drying clothes, such as, for example, clothes dryers, outdoor and indoor clothes lines, hangers for hanging clothes and laying clothes on top of the washer or a piece of furniture, may not adequately and conveniently address the needs of some items of clothing. Further, the conventional clothes drying methods and devices may structurally damage the clothes and thereby decrease the longevity and appearance of the clothing.

More particularly, delicate items of clothes may suffer from undesirable effects as a result of traditional drying devices and methods. For example, such clothes may shrink as a result of being dried in heated clothes driers or the fabric may stretch or otherwise deform as a result of being hung from a hanger to dry. Drying clothes items by laying them flat on a piece of furniture or other surface is often a preferred approach since doing so avoids most of the above-described undesirable effects of the other methods and devices. However, drying clothes by laying them flat can lead to mold or mildew, condensation, and typically produces slow and non-uniform drying. Furthermore, drying even a few items of clothes by laying them flat requires relatively large amounts of surface space upon which to lay the items out flat. Many households may not have sufficient space or surfaces to dry more than a few clothing items.

Therefore, what is needed in the art is a method and apparatus that provides the surface space for the flat drying of clothes items.

Furthermore, what is needed in the art is a method and apparatus for the flat drying of clothes that improves (reduces) drying time and provides more uniform drying.

### SUMMARY OF THE INVENTION

The present invention provides a cabinet for flat-drying of items of clothes.

The present invention comprises, in one form thereof, a cabinet with a plurality of shelves. The shelves are movable between a first position wherein the shelves are disposed substantially entirely within the cabinet and a second position wherein the shelves extend at least partially from within the cabinet. The shelves are substantially rigid and define a plurality of small-diameter holes therethrough. At least one fan is disposed in association with the cabinet to create a flow of air within and/or through the cabinet.

An advantage of the present invention is that delicate and other items of clothing are able to be laid out flat to dry without causing stretching or other distortion to the item of clothing.

A further advantage of the present invention is that the amount of space required to flat dry several items of clothing is reduced.

A still further advantage of the present invention is that the amount of time to flat dry one or more articles of clothing is reduced by assisted air circulation, and relatively even drying is achieved.

### BRIEF DESCRIPTION OF THE DRAWINGS

The above-mentioned and other features and advantages of this invention, and the manner of attaining them, will become apparent and be more completely understood by reference to the following description of one embodiment of the invention when read in conjunction with the accompanying drawings, wherein:

FIG. 1 is a perspective front view of one embodiment of a flat dry clothes drying apparatus of the present invention;

FIG. 2 is a side view of the flat dry clothes drying apparatus of FIG. 1, and shows a drying surface in the extended or pulled-out position; and

FIG. 3 is a perspective view of one drying surface of the flat dry apparatus of FIG. 1.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DESCRIPTION OF THE PREFERRED EMBODIMENTS

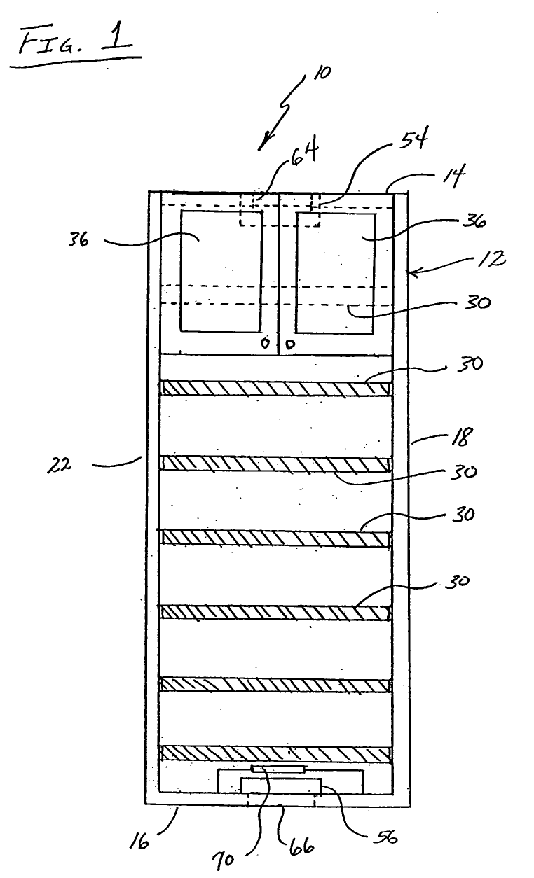

Referring now to the drawings, and particularly to FIG. 1, one embodiment of a flat dry clothes drying apparatus of the present invention. Generally, clothes drying apparatus 10 enables a plurality of clothing items to be laid out flat for drying and actively promotes air flow for relatively even and expedient drying of the clothing items.

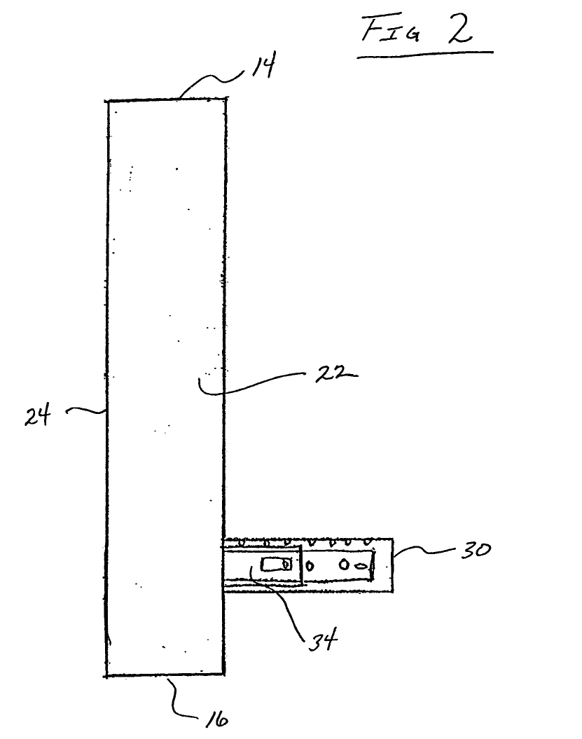

Apparatus 10 includes enclosure or cabinet 12 having a top 14, bottom 16, sidewalls 18 and 22, rear wall 24 and shelves 30. Each of the top 14, bottom 16, sidewalls 18 and 22, and rear wall 24 (FIG. 2) are interconnected to each other to form cabinet 12. Shelves 30 are connected to cabinet 12. Preferably, shelves 30 are slidingly connected, such as, for example, by sliding shelf guides 34 (FIG. 2), to sidewalls 18 and 22. Thus, shelves 30 are easily movable between a first or stored position wherein the shelves are substantially entirely disposed within cabinet 12 and a second or extended position wherein the shelves, or at least a significant portion thereof, extend from the interior of cabinet 12 to thereby permit easy access to the shelf to place an article of clothing thereon or to remove an article of clothing therefrom.

Cabinet 12 further includes doors 36 (only one pair shown), which are opened to access the interior of cabinet 12 and/or shelves 30 and are closed to conceal the contents of cabinet 12. In the embodiment shown, doors 36 close only a portion of cabinet 12. However, it is to be understood that cabinet 12 can be alternately configured, such as, for example, with a single pair of doors 36 that close the entire cabinet 12 or additional pairs of doors 36 each closing respective portions of cabinet 12.

Cabinet 12, including top 14, bottom 16, sidewalls 18 and 22, rear wall 24, shelves 30, and doors 36, is preferably constructed of wood, fiberboard or melamine. Of course, cabinet 12 can be constructed of other suitable materials.

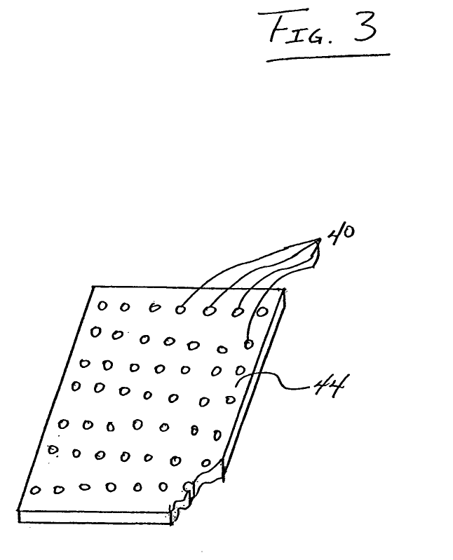

Shelves 30, as discussed above, are preferably constructed of wood, fiberboard or melamine, and as such are substantially rigid. Shelves 30 provide a substantially level and flat support surface for items of clothing placed thereon. As best shown in FIG. 3, shelves 30 include a plurality of vent holes 40 that extend through shelves 30. Holes 40 are relatively small in size, such as, for example, from approximately one-quarter to approximately one-half inch in diameter, to thereby reduce sagging of clothing into holes 40 and the unsightly marks, deformations, patterns or other artifacts that might otherwise occur as a result of the drying process. Holes 40 are also relatively closely-spaced or pitched, such as, for example, spaced approximately one-quarter inch to one and one-half inch or more apart. Holes 40 facilitate and enable air flow through shelves 30 to thereby promote more rapid and more even drying of items of clothing placed on shelves 30. Shelves 30 include a waterproof surface 44.

Cabinet 12 further includes fans 54 and 56 (FIG. 1) to facilitate the flow of air through cabinet 12 and thereby promote the drying of articles of clothing on shelves 30. As shown, fan 54 is disposed on top 14 of cabinet 12 and fan 56 is disposed on bottom 16 of cabinet 12. Fans 54 and 56 cooperate to move air into, through, and out of cabinet 12 via corresponding openings 64 and 66, such as, for example, holes, vents or other openings. For example, fan 54 draws air into cabinet 12 through openings 64 in the top 14 thereof, pushes or moves that air downward within cabinet 12, and fan 56 draws the air within cabinet 12 downward and out bottom 16 of cabinet 12 through openings 66. As will be appreciated, apparatus 10 can be alternately configured to direct air flow from top to bottom as described above, or to direct air flow from bottom to top, side to side, side to top, side to bottom, back to top, back to bottom, or in other directions. Further, fans 54 and 56 can be alternately configured such that each fan draws air into cabinet 12, with the air thus drawn in being permitted to simply flow in an otherwise unassisted manner out of cabinet 12. Moreover, fans 54 and/or 56 can be optionally configured to include one or more heating means 70, such as, for example, electric heating elements, to warm and/or heat and/or dehumidify the air being moved into and through cabinet 12 and thereby further promote drying.

Apparatus 10 of the present invention is especially suited for drying delicate items of clothing that require flat drying or are best dried by laying flat, such as, for example, sweaters, lingerie, delicate shirts, pants, and other delicate items of clothing. Apparatus 10 utilizes a minimum of space, and can be constructed and/or finished to match and integrate seamlessly into other cabinetry within a room, such as, for example, a laundry room, closet, or bathroom.

While the present invention has been described as having a preferred design, the invention can be further modified within the spirit and scope of this disclosure. This disclosure is therefore intended to encompass any equivalents to the structures and elements disclosed herein. Further, this disclosure is intended to encompass any variations, uses, or adaptations of the present invention that use the general principles disclosed herein. Moreover, this disclosure is intended to encompass any departures from the subject matter disclosed that come within the known or customary practice in the pertinent art and which fall within the limits of the appended claims.

1. A clothes-drying apparatus, comprising:
a cabinet;
a plurality of shelves associated with said cabinet, said shelves being movable between a first position wherein the shelves are disposed substantially entirely within said cabinet and a second position wherein said shelves extend at least partially from within said cabinet, said shelves defining a plurality of small-diameter holes therethrough; and
at least one fan disposed in association with said cabinet to create a flow of air at least one of within and through said cabinet.

2. The clothes-drying apparatus of claim 1, wherein said holes are from approximately one-quarter to approximately one-half inch in diameter.

3. The clothes-drying apparatus of claim 1, wherein said shelves are substantially rigid.

4. The clothes-drying apparatus of claim 1, wherein said cabinet defines at least one opening through which air at least one of enters and exits the cabinet.

5. The clothes-drying apparatus of claim 4, wherein each said at least one fan is associated with a corresponding one of said at least one openings.

6. The clothes-drying apparatus of claim 1, further comprising at least one heating means means heating at least one of air within said cabinet and air flowing into said cabinet.

7. A method of drying items of clothing, comprising:
laying the item of clothing flat upon a shelf, the shelf being disposed in an extended position, the shelf defining a plurality of small-diameter spaced-apart holes therethrough;
moving the shelf to a stored position wherein the shelf is disposed substantially entirely within a cabinet; and
promoting a flow of air through the cabinet.

8. The method of drying items of clothing of claim 7, wherein said shelves are substantially rigid.

9. The method of drying items of clothing of claim 7, comprising the further step of heating at least one of the air within and the air flowing into the cabinet.

10. A clothes-drying apparatus, comprising:
a cabinet;
at least two air-flow openings defined by said cabinet;
a plurality of shelves associated with said cabinet, said shelves being movable between a first position wherein the shelves are disposed substantially entirely within said cabinet and a second position wherein said shelves extend at least partially from within said cabinet, said shelves being substantially rigid and defining a plurality of small-diameter holes therethrough;
at least two fans, each of said at least two fans being associated with a corresponding one of said at least two air-flow openings, at least one of said fans configured to draw air through its corresponding opening and into said cabinet, at least one of said fans configured to draw air through said opening and out of said cabinet; and
at least one heating means for heating at least one of air within and air flowing into said cabinet.
